(19) United States
(12) Patent Application Publication
(10) Pub. No.: US 2019/0184760 A1
(43) Pub. Date: Jun. 20, 2019

(54) APPARATUSES AND METHODS FOR IMPROVING CHUNKING AND CRACKING RESISTANCE OF TIRES

(71) Applicant: Bridgestone Bandag, LLC, Muscatine, IA (US)

(72) Inventors: Andrew D. Cerny, Riverside, IA (US); Terry A. Westaway, Conesville, IA (US); Robert G. Otting, Illinois City, IL (US); Kimberlee C. Nietzel, Muscatine, IA (US); Susan M. Jensen, Muscatine, IA (US)

(21) Appl. No.: 16/323,569

(22) PCT Filed: Aug. 3, 2017
(86) PCT No.: PCT/US17/45313

§ 371 Date: Feb. 6, 2019

Related U.S. Application Data
(60) Provisional application No. 62/371,921, filed on Aug. 8, 2016.

(51) Int. Cl. B60C 11/12; B60C 11/04

(52) U.S. Cl. CPC B60C 11/1236; B60C 11/1259; B60C 2011/129; B60C 2011/1209; B60C 11/04

(57) ABSTRACT

A tire includes a tire tread having a plurality of tread elements positioned thereon, and a plurality of grooves provided therebetween. A first set of sipes extend from a circumferential axis of the tire tread towards a first axial end of the tire tread at a non-zero angle with respect to an axial axis of the tire tread. A second set of sipes extend from the circumferential axis towards a second axial end of the tire tread opposite the first axial end at the non-zero angle such that a first sipe end of each of the first set of sipes may be positioned proximate to a second sipe end of each of the second set of sipes. Each of the first and second set of sipes extend beyond 50% of a half width of the tire, and have a sipe depth greater than 50% of a height of the plurality of tread elements.

### FIELD

This application generally to apparatuses and methods of improving chunking and cracking resistance of tires.

### BACKGROUND OF THE DISCLOSURE

Sipes are sometimes cut or molded into tread to improve traction. Sipes may be formed in ribs and blocks of a tread and may exhibit the effect of cutting through water films on road surfaces, similar to edges of grooves. Sipes may also facilitate deformation of ribs and blocks, and may inhibit tire hysteresis loss. A sipe pattern can be within one or more blocks, ribs or lugs of the tire tread and included within the boundary of each tread element. Sipes may be cut straight across the tire tread, or at a constant a bias angle within tread elements. Sipes may weaken the tread blocks, and make them more susceptible to tearing or chunking off pieces of rubber. This may cause some tearing and chipping to occur at the edges of the tread blocks when the tire is subjected to side scrub.

### BRIEF SUMMARY

Some embodiments relate to methods and apparatus for increasing chunking and cracking resistance of tire treads, and more particularly, apparatus and methods in which chevron or offset chevron shaped sipes are provided on a tire tread causing significant increase in chunking and cracking resistance of the tire tread.

In some embodiments, a tire may include a tire tread defining a rotational axis. A plurality of tread elements may be positioned on the tire tread surface so as to provide a tread pattern. The plurality of tread elements may be positioned at least one of axially or circumferentially on the tire tread surface. A plurality of grooves may be provided between the plurality of tread elements. A first set of sipes may extend from a circumferential axis of the tire tread towards a first axial end of the tire tread at a non-zero angle with respect to an axial axis of the tire tread. A second set of sipes may extend from the circumferential axis towards a second axial end of the tire tread opposite the first axial end at the non-zero angle with respect to the axial axis such that a first sipe end of each of the first set of sipes may be positioned proximate to a second sipe end of each of the second set of sipes. Each of the first set of sipes and the second set of sipes may extend beyond 50% of a half width of the tire tread measured from the circumferential axis. Moreover, each of the first set of sipes and the second set of sipes may have a sipe depth greater than 50% of a height of the plurality of tread elements.

In some embodiments, a tread pattern for a tire tread may include a plurality of tread elements positioned on a tire tread first surface so as to provide the tread pattern. The plurality of tread elements may be positioned at least one of axially or circumferentially on the tire tread surface. A plurality of grooves may be provided between the plurality of tread elements. A first set of sipes may extend from a circumferential axis of the tire tread towards a first axial end of the tire tread at a non-zero angle with respect to an axial axis of the tire tread. A second set of sipes may extend from the circumferential axis towards a second axial end of the tire tread opposite the first axial end at the non-zero angle with respect to the axial axis such that a first sipe end of each of the first set of sipes may be positioned proximate to a second sipe end of each of the second set of sipes. Each of the first set of sipes and the second set of sipes may extend beyond 50% of a half width of the tire measured from the circumferential axis. Moreover, each of the first set of sipes and the second set of sipes may have a sipe depth greater than 50% of a height of the plurality of tread elements.

In some embodiments, a method of increasing chunking and cracking resistance of a tire tread of a tire, which includes a plurality of tread elements, includes defining a first set of sipes in the tire tread. The first set of sipes may extend from a circumferential axis of the tire tread towards a first axial end of the tire tread at a non-zero angle with respect to an axial axis of the tire tread. A second set of sipes are provided in the tire tread extending from the circumferential axis towards a second axial end of the tire tread opposite the first axial end at the non-zero angle with respect to the axial axis such that a first sipe end of each of the first set of sipes may be positioned proximate to a second sipe end of each of the second set of sipes. Each of the first set of sipes and the second set of sipes may extend beyond 50% of a half width of the tire tread measured from the circumferential axis, and may have a sipe depth greater than 50% of a height of the plurality of tread elements.

All combinations of the foregoing concepts and additional concepts discussed in greater detail below (provided such concepts are not mutually inconsistent) are contemplated as being included within this disclosure. In particular, all combinations of claimed subject matter appearing at the end of this disclosure are contemplated as being included within this disclosure.

### BRIEF DESCRIPTION OF THE DRAWINGS

The foregoing and other features will become more fully apparent from the following description and appended claims, taken in conjunction with the accompanying drawings.

FIG. 1 is a front view of a portion of a tire tread including chevron shaped sipes, according to some embodiments.

FIG. 2 is a side cross-section view of a tread element of the tire tread of FIG. 1.

FIG. 3 is a front view of a portion of a tire tread including offset chevron shaped sipes, according to some embodiments.

FIG. 4 is a front view of a portion of a tire tread including offset chevron shaped sipes, according to some embodiments.

FIG. 5 is a front view of a portion of a tire tread including chevron shaped sipes, according to some embodiments.

FIG. 6 is a schematic flow diagram of an example method for increasing chunking and cracking resistance of a tire tread, according to some embodiments.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the disclosure. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Some embodiments relate to methods and apparatus for increasing resistance of tire treads to chunking and cracking, and more particularly, apparatus and methods in which chevron or offset chevron shaped sipe pattern is provided on a tire tread causing significant increase in chunking and cracking resistance of the tire tread.

For ease of understanding this disclosure the following terms are disclosed:

“Aspect ratio” of the tire may refer to the ratio of its section height (SH) to its section width (Sw) multiplied by 100% for expression as a percentage.

“Asymmetric tread” may refer to a tread that has a tread pattern not symmetrical about the centerplane or an equatorial plane EP of the tire.

“Axial” and “axially” may refer to lines or directions that are parallel to an axis of rotation of the tire.

“Circumferential” may refer to lines or directions extending along the perimeter of the surface of the annular tire tread perpendicular to an axial direction.

“Groove” may refer to an elongated void area in a tire tread that may extend circumferentially or laterally about the tire tread in a straight, curved, zigzag or any other suitable manner. Circumferentially and laterally extending grooves may sometimes have common portions. The “groove width” may be equal to a tread surface area occupied by a groove or groove portion, thus, the groove width may be its average width over its length. Grooves may be of varying depths in a tire. The depth of a groove may vary around the circumference of the tread, or the depth of one groove may be constant but vary from the depth of another groove in the tire. In some embodiments, the depth of the groove may be constant along the tire. If such narrow or wide grooves are of substantially reduced depth as compared to wide circumferential grooves which they interconnect, they may be regarded as forming “tie bars” tending to maintain a rib-like character in the tread region involved.

“Net-to-gross ratio” may refer to the total area of ground contacting tread elements between the lateral edges around the entire circumference of the tread divided by the gross area of the entire tread between the lateral edges.

“Non-directional tread” may refer to a tread that has no preferred direction of forward travel and is not required to be positioned on a vehicle in a specific wheel position or positions to ensure that the tread pattern is aligned with the preferred direction of travel. Conversely, a directional tread pattern may have a preferred direction of travel requiring specific wheel positioning.

“Radial” and “radially” may refer to directions radially toward or away from the axis of rotation of the tire.

“Rib” may refer to a circumferentially extending strip of rubber on the tread with at least one circumferential groove and either a second such groove or a lateral edge, the strip being laterally undivided by full-depth grooves.

“Sipe” may refer to small slots molded or cut into the tread elements of the tire that subdivide the tread surface and may improve traction.

“Tread element” or “traction element” may refer to a rib, lug or a block element.

“Lugs” may refer to the section of the tread element that make contact with a surface.

“Voids” may refer to spaces that are located between the lugs.

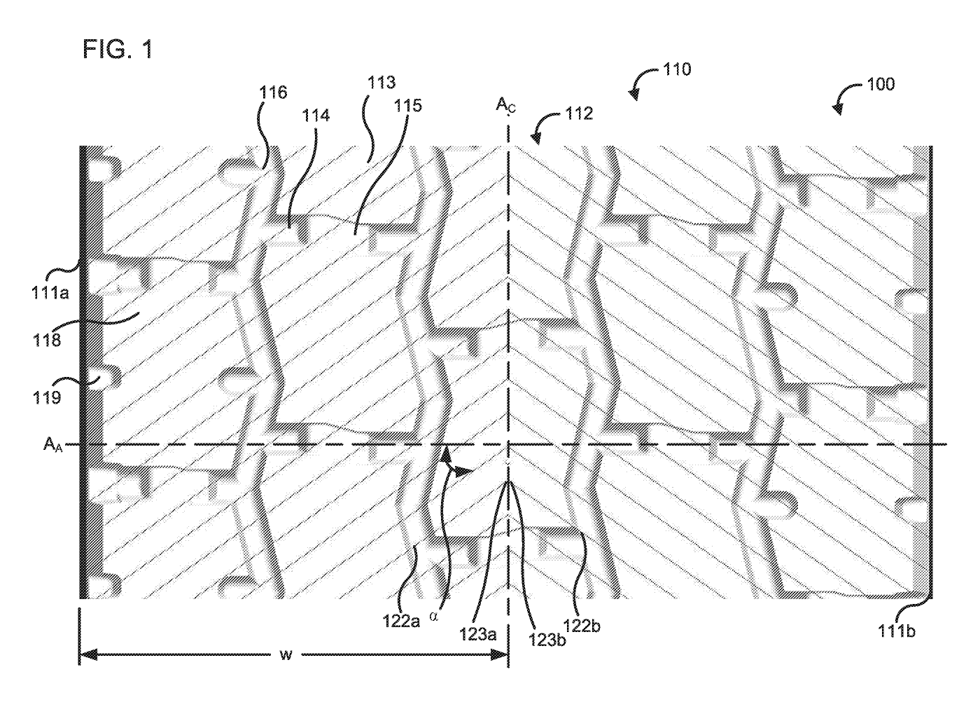

FIG. 1 is a front view of a portion of a tire tread 100 of a tire, according to some embodiments. The tire may include a pneumatic tire. The tire tread 100 may include a rotational axis and a tread pattern 110. Specifically, the tire tread 100 may include a plurality of tread elements 112 positioned on a surface of the tire tread 100 that provide the tread pattern 110. The tire tread 100 may be molded with the tire, or molded separately and thereafter coupled to an outer surface of the tire (e.g., via an adhesive, curing, fusion bonding, heat bonding, etc.).

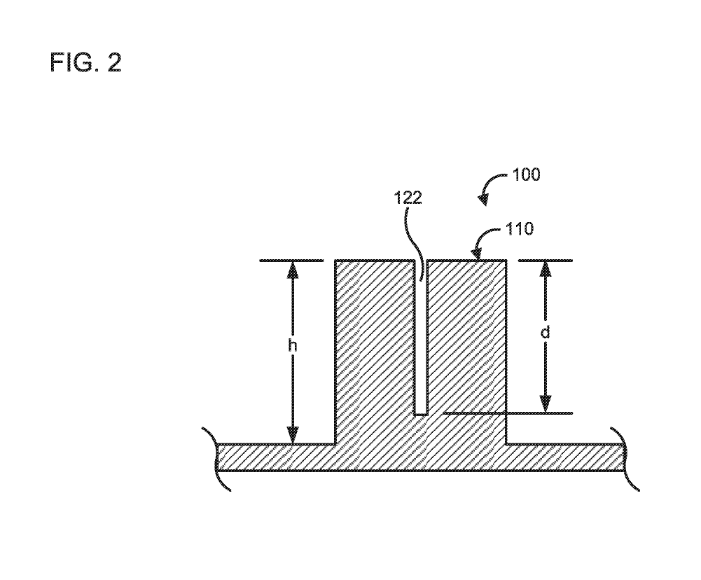

The plurality of tread elements 112 may include a plurality of circumferential lugs 113 separated by voids 114. A connecting block 115 may be positioned in the void 114 between each of the lugs 113, and coupled to each of the adjacent lugs 113. FIG. 2 is a side cross-section view of a portion of the tire tread 100 including single tread element 112. As seen in FIG. 2, each tread element has a height “h”. A height of each of the connecting block 115 may be smaller than the height h of the tread elements 112 such that the connecting blocks 115 do not contact the surface on which the tire tread 100 is positioned. Furthermore, the tire tread 100 may have a half width “w” (FIG. 1) measured from a circumferential axis A_{C} of the tire tread 100 to an axial end thereof.

A plurality of circumferential grooves 116 may be provided between each of the plurality of tread elements 113. The tread elements 112 may also include shoulder blocks 118 positioned at axial ends of the tire tread 110. A plurality of notches 119 or slots may be provided in the shoulder blocks 118.

It is to be appreciated that while the tire tread 100 is shown as having a particular tread pattern 110, the tire tread 100 may have any suitable tread pattern. For example, the plurality of tread elements 112 may be axially or circumferentially positioned on a surface of the tire tread 100, include straight, curved or zig zag grooves, a pitch pattern, a non-directional tread pattern, a symmetric tread or an asymmetric tread. Furthermore, the tire tread 100 may have any suitable aspect ratio or net-to-gross ratio.

The tire tread 100 may include a first set of sipes 122a extending from the circumferential axis of the tire tread 100 towards a first axial end 111a of the tire tread 100 at a non-zero angle α with respect to an axial axis A_{A} of the tire tread 100 (e.g., in the range of about 5-40 degrees inclusive of all ranges and values therebetween). The tire tread 100 may also include a second set of sipes 122b extending from the circumferential axis A_{C} towards a second axial end 111b of the tire tread 100 opposite the first axial end. Each of the second set of sipes 122b may be inclined at the non-zero angle α with respect to the axial axis A_{A}. The first set of sipes 122a and the second set of sipes 122b (collectively referred to herein as “the sipes 122”) may be molded into the tire tread 100, for example during a molding operation of the tire tread 100, or cut into the tread elements 112 after molding of the tire tread 100. Moreover, the sipes 122 may be inclined towards a direction of rotation of the tire tread 100 or away from the direction of rotation.

Each sipe included in the first set of sipes 122a and the second set of sipes 122b, respectively may be positioned parallel to an adjacent sipe at any suitable pitch or distance therefrom. In some embodiments, the distance may be in a range of 5 mm to 40 mm inclusive of all ranges and values therebetween. Furthermore, the distance or pitch may be fixed or variable.

A first sipe end 123a of each of the first set of sipes 122a may be positioned proximate to a second sipe end 123b of each of the second set of sipes 122b. For example, the first sipe end 123a and the second sipe end 123b of each of the first set of sipes 122a and the second set of sipes 122b, respectively may intersect the circumferential axis A_{C}. In some embodiments, the first sipe end 123a and the second sipe end 123b may intersect each other such that the combination of the sipes 122 may comprise a chevron shape, as shown for example in FIG. 1. In some embodiments, the first sipe end 123a and the second sipe end 123b may be offset from each other so that the combination of each of the sipes 122 comprise an offset chevron shape.

Each of the sipes 122 may extend beyond 50% of a half width of the tire tread 100 measured from the circumferential axis A_{C}. For example, each of the sipes 122 may extend between 60% to 100% of the half width w of the tire tread 100 inclusive of all ranges and values therebetween. Furthermore, each of the sipes 122 may have a sipe depth d greater than 50% of the height h of each of the plurality of tread elements 112, measured from a top surface of the tread element 112 positioned opposite the surface of the tire tread 100 on which the tread elements 112 are positioned. For example, each of the sipes 122 may have a sipe depth d in a range of 60% to 100% of the height h of the plurality of tread elements 112 inclusive of all ranges and values therebetween. In some embodiments, each of the sipes 122 may have a sipe depth greater than 100% of the height of the plurality of tread elements (e.g., about 101% to 110% of the height h of the plurality of tread elements 112 inclusive of all ranges and values therebetween).

Expanding further, in some embodiments as shown in FIG. 1, the first sipe end 123a and the second sipe end 123b of the first set of sipes 122a and the second set of sipes 122b, respectively intersect each other such that the sipes 122 provide a chevron shape. Each of the sipes 122 of the tire tread 100 of FIG. 1 may extend from the circumferential axis A_{C} at an angle α of about 35 degrees to a corresponding axial end 111a/b of the tire tread 110 so that the sipes 122 may extend to 100% of the half width of the tire tread 110. The sipes 122 may have a sipe depth d of about 60% of the height h of each tread element 112, but may be cut to have a deeper sipe depth (e.g., 60%, 70%, 80%, 90%, 100% or 110% of the height h of the tread element 112 inclusive of all ranges and values therebetween).

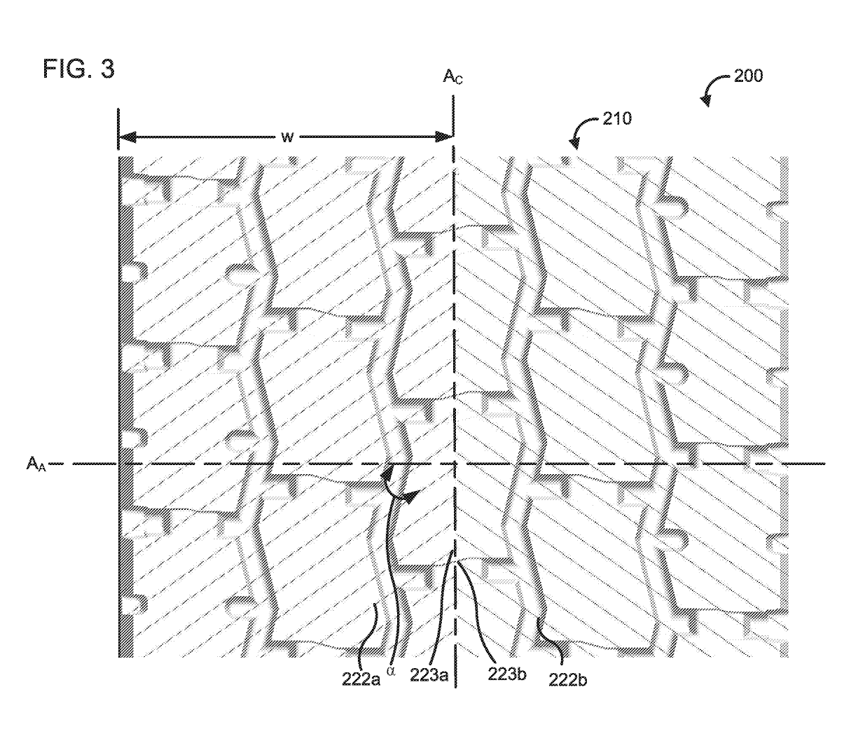

FIG. 3 is a top view of a portion of a tire tread 200 of a tire according to some embodiments. The tire tread 200 includes a tread pattern 210. The tread pattern 210 may be substantially similarly to the tread pattern 110 of the tire tread 100 and is therefore, not described in further detail herein.

A first set of sipes 222a and a second set of sipes 222b (collectively referred to herein as “the sipes 222”) extend from a circumferential axis A_{C} towards opposite axial ends of the tire tread 200. For example, each of the sipes 222 may extend to 100% of a half width w of the tire tread 200, as shown in FIG. 3. Each of the second set of sipes 222b is also inclined at the non-zero angle α with respect to the axial axis A_{A}, for example at an angle of about 35 degrees. Furthermore, the sipes 222 may have any suitable sipe depth, for example in the range of 60% to 110% of a height of a plurality of tread elements of the tire tread 200, as described with respect to FIG. 1.

Each sipe included in the first set of sipes 222a and the second set of sipes 222b, respectively may be positioned parallel to an adjacent sipe at any suitable pitch or distance therefrom. In some embodiments, the distance may be in a range of 5 mm to 40 mm inclusive of all ranges and values therebetween. Furthermore, the distance or pitch may be fixed or variable.

A first sipe end 223a of each of the first set of sipes 222a may be positioned proximate to a second sipe end 223b of each of the second set of sipes 222b. For example, the first sipe end 223a and the second sipe end 223b of each of the first set of sipes 222a and the second set of sipes 222b may intersect the circumferential axis A_{C}. The first sipe end 222a and the second sipe end 223b may be offset from each other so that the combination of each of the sipes 222 provides an offset chevron shape, as shown in FIG. 3.

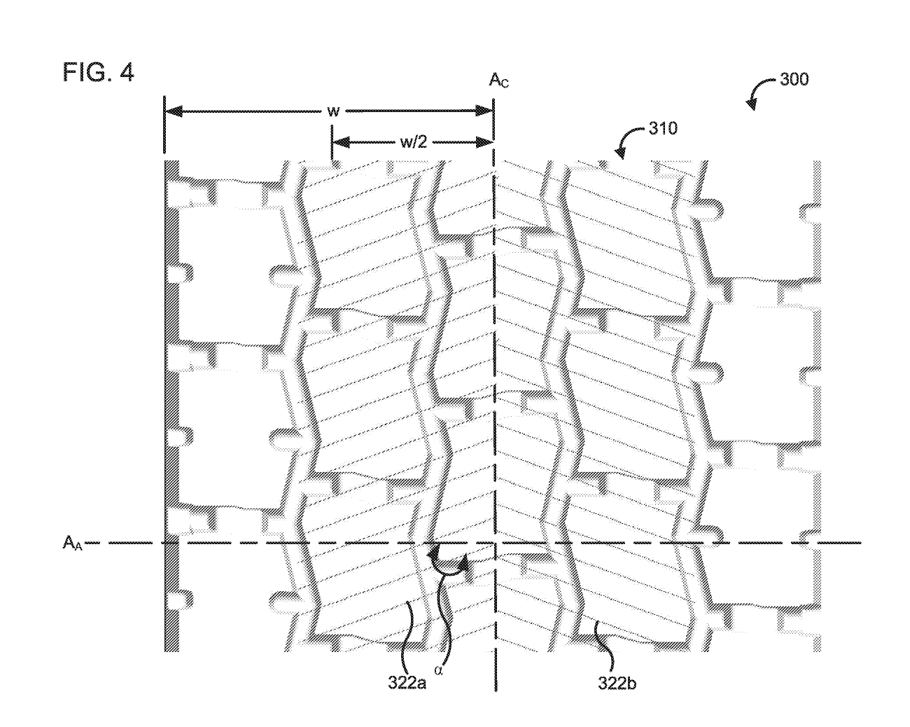

FIG. 4 is a top view of a portion of a tire tread 300 of a tire according to some embodiments. The tire tread 300 includes a tread pattern 310. The tread pattern 310 may be substantially similarly to the tread pattern 110 of the tire tread 100.

A first set of sipes 322a and a second set of sipes 322b (collectively referred to herein as “the sipes 322”) extend from a circumferential axis A_{C} towards opposite axial ends of the tire tread 200, and are positioned in an offset chevron pattern. As shown in FIG. 4, each of the sipes 322 may extend greater than 50% of a half width w of the tire tread 200, for example about 60% of the half width w. Each of the second set of sipes 322b is also inclined at the non-zero angle α with respect to the axial axis A_{A}, for example an angle of about 20 degrees. Furthermore, the sipes 322 may have any suitable sipe depth, for example in the range of 60% to 110% of a height of a plurality of tread elements of the tire tread 300, such as described with respect to FIG. 1.

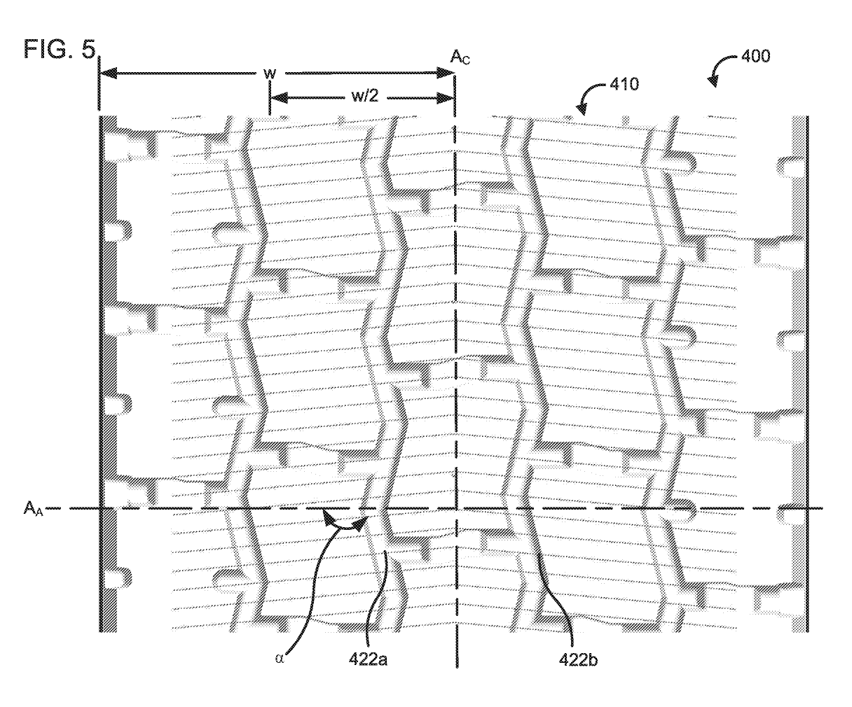

FIG. 5 is a top view of a portion of a tire tread 400 of a tire according to an embodiment. The tire tread 400 includes a tread pattern 410. The tread pattern 410 may be substantially similarly to the tread pattern 110 of the tire tread 100.

A first set of sipes 422a and a second set of sipes 422b (collectively referred to herein as “the sipes 422”) extend from a circumferential axis A_{C} towards opposite axial ends of the tire tread 400, and are positioned in a chevron pattern. As shown in FIG. 5, each of the sipes 422 may extend greater than 50% of a half width w of the tire tread 400, for example about 80% of the half width w. Each of the second set of sipes 422b is also inclined at the non-zero angle α with respect to the axial axis A_{A}, for example an angle of about 20 degrees. Furthermore, the sipes 422 may have any suitable sipe depth, for example in the range of 60% to 110% of a height of a plurality of tread elements of the tire tread 400, such as described with respect to FIG. 1.

The chevron or offset chevron sipes described herein may significantly improve chunking or cracking resistance of the tire tread irrespective of the tire tread pattern of the tire tread. A scale of 0-5 rating points was developed to quantify chunking resistance of tires, with 0 being the worst to 5 being the best. Straight sipes, chevron shaped sipes and offset chevron sipes were cut in bus tires, and dumpster truck tires. The cracking and chunking performance of the tires was rated on the scale. Changing the sipes from straight sipes to chevron shaped or offset chevron shaped sipes resulted in an improvement in cracking and chunking resistance in a range of 0.2 rating points to as much as 1.81 rating points on the scale.

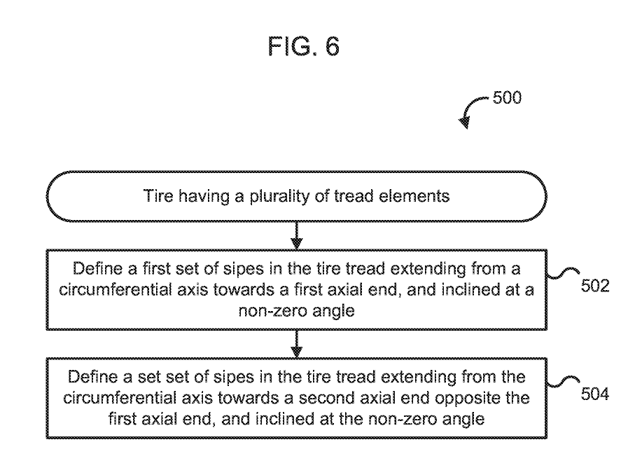

FIG. 6 is a schematic flow diagram of an example method 500 for improving chunking and cracking resistance of a tire tread (e.g., the tire tread 100/200/300/400) of a tire. The tire tread includes a plurality of tread elements (e.g., the tread elements 112) which provide a tread pattern (e.g., the tread pattern 110/210/310/410).

The method 500 includes defining a first set of sipes in the tire tread extending from a circumferential axis of the tire tread towards a first axial end of the tire tread at a non-zero angle with respect to an axial axis of the tire tread at 502. For example, the first set of sipes 122a/222a/322/422a may be cut in the tread elements 112/212/312/412. The non-zero angle may be in the range of 5 degrees to 40 degrees.

Furthermore, a second set of sipes are provided in the tire tread extending from the circumferential axis towards a second axial end of the tire tread opposite the first axial end at the non-zero angle with respect to the axial axis at 504. For example, the second set of sipes 122b/222b/322b/422b may be cut in the tread elements 112/212/312/412. A first sipe end of each of the first set of sipes is positioned proximate to a second sipe end of each of the second set of sipes, so that the first set of sipes and the second set of sipes in combination comprise a chevron or offset chevron pattern.

Each sipe included in the first set of sipes and the second set of sipes, respectively may be positioned parallel to an adjacent sipe at any suitable pitch or distance therefrom (e.g., a range of 5 mm to 40 mm inclusive of all ranges and values therebetween. Furthermore, the distance or pitch may be fixed or variable.

Each of the first set of sipes and the second set of sipes extend beyond 50% of a half width of the tire tread measured from the circumferential axis. For example, each of the sipes may extend between 60% to 100% of the half width w of the tire tread inclusive of all ranges and values therebetween. Furthermore, each of the sipes may have a sipe depth d greater than 50% of the height h of each of the plurality of tread elements, measured from a top surface of the tread element positioned opposite the surface of the tire tread on which the tread elements are positioned. For example, each of the sipes may have a sipe depth d in a range of 60% to 100% of the height h of the plurality of tread elements inclusive of all ranges and values therebetween. In some embodiments, each of the sipes may have a sipe depth greater than 100% of the height of the plurality of tread elements (e.g., about 101% to 110% of the height h of the plurality of tread elements inclusive of all ranges and values therebetween).

The use of the terms “a” and “an” and “the” and similar referents refer to both the singular and the plural, unless otherwise indicated herein or clearly contradicted by context. The terms “comprising,” “having,” “including,” and “containing” are open-ended terms (e.g., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter and does not pose a limitation unless otherwise claimed. No language in the specification should be construed as being absolute on a scale but should only indicate relative improvement, nothing should be construed as indicating any non-claimed element as essential.

It should be noted that the term “example” as used herein to describe some embodiments is intended to indicate that some embodiments are possible examples, representations, and/or illustrations of possible embodiments (and such term is not intended to connote that some embodiments are necessarily extraordinary or superlative examples).

As used herein, the terms “about” and “approximately” generally mean plus or minus 10% of the stated value. For example, about 0.5 would include 0.45 and 0.55, about 10 would include 9 to 11, about 1000 would include 900 to 1100.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

Preferred embodiments are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While this specification contains many specific implementation details, these should not be construed as limitations on the scope of this disclosure or of what may be claimed, but rather as descriptions of features specific to particular implementations. Certain features described in this specification in the context of separate implementations can also be implemented in combination in a single implementation. Various features described in the context of a single implementation can also be implemented in multiple implementations separately or in any suitable subcombination. Although features may be described above as acting in certain combinations and even initially claimed as such, one or more features from a claimed combination can in some cases be excised from the combination, and the claimed combination may be directed to a subcombination or variation of a subcombination.

1. A tire, comprising:
a tire tread with a rotational axis;
a plurality of tread elements positioned on a tire tread surface so as to comprise a tread pattern, the plurality of tread elements positioned at least one of axially or circumferentially on the tire tread surface;
a plurality of grooves provided between the plurality of tread elements;
a first set of sipes extending from a circumferential axis of the tire tread towards a first axial end of the tire tread at a non-zero angle with respect to an axial axis of the tire tread; and
a second set of sipes extending from the circumferential axis towards a second axial end of the tire opposite the first axial end at the non-zero angle with respect to the axial axis such that a first sipe end of each of the first set of sipes is positioned proximate to a second sipe end of each of the second set of sipes,
wherein each of the first set of sipes and the second set of sipes extend beyond 50% of a half width of the tire tread relative to the circumferential axis, and wherein each of the first set of sipes and the second set of sipes have a sipe depth greater than 50% of a height of the plurality of tread elements.

2. The tire of claim 1, wherein the first sipe end intersects the second sipe end at the circumferential axis so that the combination of each of the first set of sipes and the second set of sipes comprise a chevron shape.

3. The tire of claim 1, wherein the first sipe end and the second sipe end are offset from each other so that the combination of each of the first set of sipes and the second set of sipes comprise an offset chevron shape.

4. The tire of claim 1, wherein each of the first set of sipes and the second set of sipes extend between 60% to 100% of the half width of the tire tread.

5. The tire of claim 1, wherein each of the first set of sipes and the second set of sipes have a sipe depth in a range of 60% to 100% of the height of the plurality of tread elements.

6. The tire of claim 5, wherein each of the first set of sipes and the second set of sipes have a sipe depth greater than 100% of the height of the plurality of tread elements.

7. The tire of claim 1, wherein the non-zero angle is in a range of 5 degrees to 40 degrees with respect to the axial axis.

8. The tire of claim 1, wherein the tire is a pneumatic tire.

9. A tread pattern for a tire tread, comprising:
a plurality of tread elements positioned on a tire tread first surface providing the tread pattern, the plurality of tread elements positioned at least one of axially or circumferentially on the tire tread first surface;
a plurality of grooves provided between the plurality of tread elements;
a first set of sipes extending from a circumferential axis of the tire tread towards a first axial end of the tire tread at a non-zero angle with respect to an axial axis of the tire tread; and
a second set of sipes extending from the circumferential axis towards a second axial end of the tire tread opposite the first axial end at the non-zero angle with respect to the axial axis such that a first sipe end of each of the first set of sipes is positioned proximate to a second sipe end of each of the second set of sipes,
wherein each of the first set of sipes and the second set of sipes extend beyond 50% of a half width of the tire measured along the circumferential axis, and wherein each of the first set of sipes and the second set of sipes have a sipe depth greater than 50% of a height of the plurality of tread elements.

10. The tread pattern of claim 9, wherein the first sipe end intersects the second sipe end at the circumferential axis so that the combination of each of the first set of sipes and the second set of sipes provide a chevron shape.

11. The tread pattern of claim 9, wherein the first sipe end and the second sipe end are offset from each other so that the combination of each of the first set of sipes and the second set of sipes provide an offset chevron shape.

12. The tread pattern of claim 9, wherein each of the first set of sipes and the second set of sipes extend between 60% to 100% of the half width of the tire tread.

13. The tread pattern of claim 9, wherein each of the first set of sipes and the second set of sipes have a sipe depth in a range of 60% to 100% of the height of the plurality of tread elements.

14. The tread pattern of claim 13, wherein each of the first set of sipes and the second set of sipes have a sipe depth greater than 100% of the height of the plurality of tread elements.

15. The tread pattern of claim 9, wherein the non-zero angle is in a range of 5 degrees to 40 degrees with respect to the axial axis.

16. A method of increasing chunking and cracking resistance of a tire tread of a tire, the tire tread comprising a plurality of tread elements, the method comprising:
forming a first set of sipes in the tire tread extending from a circumferential axis of the tire tread towards a first axial end of the tire tread at a non-zero angle with respect to an axial axis of the tire tread; and
forming a second set of sipes in the tire tread extending from the circumferential axis towards a second axial end of the tire tread opposite the first axial end at the non-zero angle with respect to the axial axis such that a first sipe end of each of the first set of sipes is positioned proximate to a second sipe end of each of the second set of sipes,
wherein each of the first set of sipes and the second set of sipes extend beyond 50% of a half width of the tire tread relative to the circumferential axis, and have a sipe depth greater than 50% of a height of the plurality of tread elements.

17. The method of claim 16, wherein a combination of the first set of sipes and the second set of sipes provide a chevron shape or an offset chevron shape.

18. The method of claim 16, wherein each of the first set of sipes and the second set of sipes extend between 60% to 100% of the half width of the tire tread.

19. The method of claim 16, wherein each of the first set of sipes and the second set of sipes have a sipe depth in a range of 60% to 100% of the height of the plurality of tread elements.

20. The method of claim 16, wherein the non-zero angle is in a range of 5 degrees to 40 degrees with respect to the axial axis.
